(19) United States
(12) Patent Application Publication
(10) Pub. No.: US 2025/0110730 A1
(43) Pub. Date: Apr. 3, 2025

(54) SOFTWARE RELEASE WORKFLOW AND RELEASABILITY DECISION ENGINE

(71) Applicant: Raytheon Company, Tewksbury, MA (US)

(72) Inventors: Jose Romero-Mariona, San Diego, CA (US); Michael Dierickx, Temecula, CA (US); Kwok Liang Poo, Lake Forest, CA (US); Jason Kong, Irvine, CA (US); Evanelyne Le, Norwalk, CA (US); James Poirier, San Diego, CA (US); Amy Lee, Cypress, CA (US); Scott McKittrick, Mission Viejo, CA (US); Klarisa Reyes, Temecula, CA (US)

(21) Appl. No.: 18/899,439

(22) Filed: Sep. 27, 2024

Related U.S. Application Data
(60) Provisional application No. 63/586,570, filed on Sep. 29, 2023.

(51) Int. Cl. G06F 8/71; H04L 9/40

(52) U.S. Cl. CPC G06F 8/71; H04L 63/1416

(57) ABSTRACT

A computing device and method including, receiving a request for a software build and, responsive to receipt of the request for the software build, retrieving source code for the software build and retrieving a software build file for the software build, the software build file defining a build pipeline. The method also includes, by the computing device, executing a workflow to implement the software build file, generating a provenance bundle based on a monitoring of the workflow, and executing a decision engine to evaluate the provenance bundle based on one or more predetermined policies to thereby generate a recommendation regarding releasability of the software build. The method further includes providing the recommendation regarding releasability of the software build to another computing device. In some cases, executing the decision engine includes evaluating cyber threat intelligence.

### CLAIM OF PRIORITY

This patent application claims the benefit of U.S. Provisional Patent Application No. 63/586,570, filed Sep. 29, 2023, which is incorporated by reference herein in its entirety.

### BACKGROUND

Software development typically includes the development of software and a build process to release the developed software. Some software development projects may involve development of an entirely new application or program, or an addition of a new feature to and/or modification of an existing feature of an existing application or program. A software build process typically involves compiling source code, resolving dependencies, performing tests, and packaging the software into a deliverable format for release to a production or delivery environment.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, receiving a request for a software build and, responsive to receipt of the request for the software build, retrieving source code for the software build and retrieving a software build file for the software build, the software build file defining a build pipeline. The method also includes, by the computing device, executing a workflow to implement the software build file, generating a provenance bundle based on a monitoring of the workflow, and executing a decision engine to evaluate the provenance bundle based on one or more predetermined policies to thereby generate a recommendation regarding releasability of the software build. The method further includes, by the computing device, providing the recommendation regarding releasability of the software build to another computing device.

In some embodiments, the executing the decision engine includes evaluating cyber threat intelligence. In one aspect, the cyber threat intelligence is determined using a machine learning (ML) model.

In some embodiments, the recommendation includes a recommendation rationale.

In some embodiments, the provenance bundle includes one or more artifacts about the software build, one of the one or more artifacts regarding actors and the actions taken by the actors.

In some embodiments, the provenance bundle includes one or more artifacts about the software build, one of the one or more artifacts regarding software license risk.

In some embodiments, the provenance bundle includes one or more artifacts about the software build, one of the one or more artifacts regarding known weaknesses in software dependencies.

In some embodiments, the provenance bundle includes one or more artifacts about the software build, one of the one or more artifacts regarding software test results.

In some embodiments, the provenance bundle includes one or more artifacts about the software build, one of the one or more artifacts regarding weaknesses in custom software included in the software build.

According to another illustrative embodiment provided to illustrate the broader concepts described herein, a computing device includes one or more non-transitory machine-readable mediums configured to store instructions and one or more processors configured to execute the instructions stored on the one or more non-transitory machine-readable mediums. Execution of the instructions causes the one or more processors to carry out a process including receiving a request for a software build and, responsive to receipt of the request for the software build, retrieving source code for the software build and retrieving a software build file for the software build, the software build file defining a build pipeline. The process also includes executing a workflow to implement the software build file, generating a provenance bundle based on a monitoring of the workflow, and executing a decision engine to evaluate the provenance bundle based on one or more predetermined policies to thereby generate a recommendation regarding releasability of the software build. The process further includes providing the recommendation regarding releasability of the software build to another computing device.

According to another illustrative embodiment provided to illustrate the broader concepts described herein, a non-transitory machine-readable medium encodes instructions that when executed by one or more processors cause a process to be carried out, the process including receiving a request for a software build and, responsive to receipt of the request for the software build, retrieving source code for the software build and retrieving a software build file for the software build, the software build file defining a build pipeline. The process also includes executing a workflow to implement the software build file, generating a provenance bundle based on a monitoring of the workflow, and executing a decision engine to evaluate the provenance bundle based on one or more predetermined policies to thereby generate a recommendation regarding releasability of the software build. The process further includes providing the recommendation regarding releasability of the software build to another computing device.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

Objects, aspects, features, and advantages of embodiments disclosed herein will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features. For clarity, not every element may be labeled in every figure. The drawings are not necessarily to scale, emphasis instead being placed upon illustrating embodiments, principles, and concepts. The drawings are not meant to limit the scope of the claims included herewith.

FIG. 1 is a block diagram of a system for software build releasability decision, in accordance with an embodiment of the present disclosure.

FIG. 2 is a diagram illustrating a cascading of policies to generate a release policy, in accordance with an embodiment of the present disclosure.

FIG. 3 is a flow diagram of an example process for a software build releasability recommendation, in accordance with an embodiment of the present disclosure.

FIG. 4 is a diagram illustrating contents of a provenance bundle, in accordance with an embodiment of the present disclosure.

FIG. 5 is a block diagram illustrating selective components of an example computing device in which various aspects of the disclosure may be implemented, in accordance with an embodiment of the present disclosure.

### DETAILED DESCRIPTION

As indicated above, software build is the process of transforming source code into a form of artifact, such as an executable, that can be installed or run on a computer. Organizations such as companies, enterprises, etc. that develop software may integrate and perform a software build process as part of a continuous integration (CI) pipeline. One primary goal of the build process is to reduce risk. For instance, organizations may need the ability to protect assets delivered from their global suppliers as well as in-service assets in an efficient and effective manner. Given current risks in the supply chain, organizations are faced with enhancing cybersecurity and software supply chain integrity as laid out in Executive Order 14028. Organizations to provide software bill of materials (SBOMs) which is a complete inventory of software components including the open-source components, the license and version information for those open-source components, and indications of any known vulnerabilities in those components. However, SBOMs are not enough as they do not provide information about scanning for weaknesses, testing, and ongoing monitoring. Addressing these and other risks presents significant challenges to organizations.

Disclosed herein are concepts, structures, and techniques for recommending whether a software build can be released. Certain embodiments described herein provide a release decision engine that provides a recommendation regarding the releasability of a software build. The release decision engine is configured to apply predetermined policies to a software build provenance bundle to generate a recommendation regarding the releasability of the software build. The software build provenance bundle includes artifacts about the software build. For example, the artifacts may describe the actors and the actions taken by the actors to build the software release, software license risk, known weaknesses in software dependencies, software test results, and weaknesses in custom software, among others. The policies specify rules that define one or more conditions that are to be satisfied for the software build to be deemed releasable. The conditions may be concerning various information associated with the artifacts in the software build provenance bundle. The policies may vary by organization (e.g., company producing the software build), project (e.g., specific software build), and/or customer (e.g., customer of the software build). In some embodiments, the release decision engine is configured to also evaluate cyber threat intelligence in generating its recommendation regarding the releasability of the software build. In some embodiments, the release decision engine can provide a signed recommendation and recommendation rationale which may be bundled with a release of the software build (also referred to herein more simply as a “software release”). The techniques described herein provide a mechanism that enables the organization to override a recommendation generated by the release decision engine.

In some embodiments, the techniques include integrating a recommendation regarding the releasability of a software build of a component of a system into a software build provenance bundle of the system that includes the component. The release decision engine can then apply configurable policies to the software build provenance bundle of the system (e.g., the aggregated software build provenance bundle of the recommendations of the individual components in the system) to generate a recommendation regarding the releasability of a build of the system. Numerous configurations and variations will be apparent in light of this disclosure.

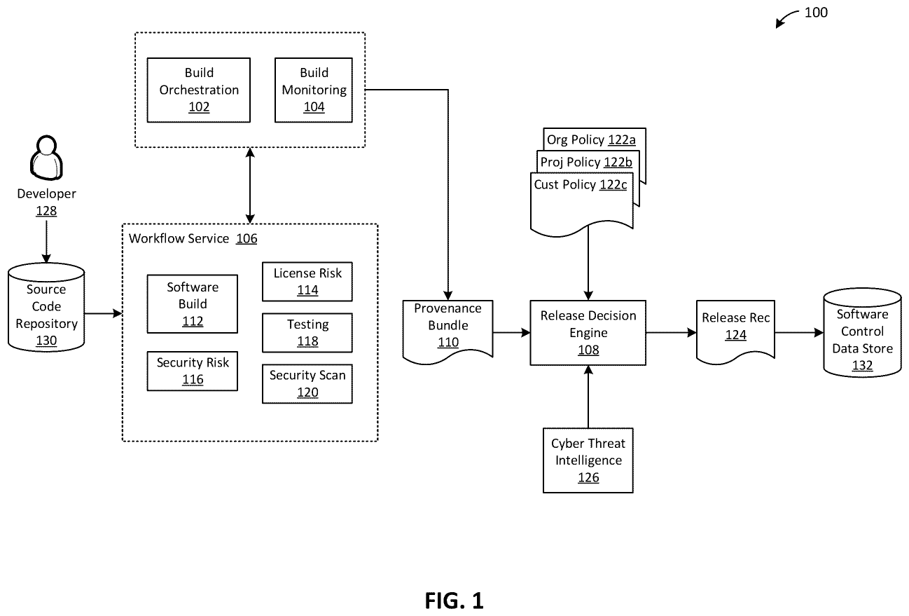

Referring now to FIG. 1, shown is a block diagram of a system 100 for software build releasability decision, in accordance with an embodiment of the present disclosure. As shown, illustrative system 100 includes a build orchestration module 102, a build monitoring module 104, a workflow service 106, and a release decision engine 108. In embodiments, components of system 100 may be located within an on-premises data center of an organization for which system 100 is deployed, within one or more cloud computing environments, or elsewhere.

Build orchestration module 102 is operable to provide control over numerous manual and automated tasks that take place across the organization to build and release software. The software can include computer programs, computer code, scripts, firmware, and other expressions of computer or processor executable logic. Build orchestration module 102 may be configured to react to events and/or activities throughout a software build process and make decisions based on outputs/results from one build task (e.g., build step) to determine and coordinate the next build task or build tasks. In more detail, build orchestration module 102 can manage the events and/or activities of various components of workflow service 106 to implement a build pipeline of a software build. That is, build orchestration module 102 can utilize the various components of workflow service 106 to execute a workflow to implement the build pipeline. The build pipeline may specify a software build process including build actions to build the software, the actors (e.g., developers, build machines/systems/infrastructure, etc.) that are authorized to take/perform the build actions to build the software, and other information about the process to build the software. Non-limiting examples of build actions in a software build process can include software verification (e.g., source code verification), source code compilation, software tests, software analysis (e.g., software license risk, software security risk, etc.), software scan (e.g., security scan), and binaries creation. The build pipeline may be defined in a software build file. In some embodiments, the software build may be integrated into or as part of the organization's continuous integration and continuous deployment (CI/CD) pipeline.

Build monitoring module 104 is operable to monitor the workflow that is being performed to build the software and generate a provenance bundle 110 which contains information (e.g., artifacts) about events that occur during building of the software. In more detail, build monitoring module 104 can monitor the various components of workflow service 106 and the various build actions performed by these components to build the software (i.e., in performing the software build process to build the software) and generate provenance bundle 110 that corresponds to that software build. For instance, provenance bundle 110 for a particular software build process can include artifacts describing the performance of the various build events and the results of the build events (e.g., results of the tests and scans) during the build of the software. In some embodiments, build monitoring module 104 can utilize a software supply chain security framework, such as the in-toto framework provided by The Linux Foundation or other suitable software security mechanism/tool, to monitor the software build process.

In some embodiments, build monitoring module 104 may be configured to interoperate with build orchestration module 102 in monitoring the various components of workflow service 106 and generating provenance bundle 110 for a particular software build. For example, upon initiating workflow service 106 for a software build, build orchestration module 102 can send a message to or otherwise initiate build monitoring module 104 that causes build monitoring module 104 to start monitoring of workflow service 106 in performing the software build process for the software build.

Workflow service 106 operates to facilitate execution of a software build process for a software build. In some embodiments, workflow service 106 may be a service (e.g., a network accessible service) that provides functionality for implementing a build pipeline of a software build. For example, as mentioned previously, build orchestration module 102 can utilize workflow service 106 to execute a workflow to implement a software build process (e.g., implement a build pipeline defined in a software build file). In the example of FIG. 1, workflow service 106 can include a software build module 112, a license risk module 114, a security risk module 116, a testing module 118, and a security scan module 120.

Software build module 112 is operable to create an executable build package for a software build. For example, software build module 112 can be configured or directed to perform various operations, such as compiling the source code of the software build, checking for dependencies, running unit tests, etc., to create an executable build package. The executable build package may be a binary, a library, executable program, or other form of artifact that can be installed or run on a target system. The activities performed to create the executable build package may vary for different programming languages and operating systems. That is, the operations performed by software build module 112 to create the executable build package may vary depending on the software build. In some cases, software build module 112 may utilize one or more of the other components of workflow service 106 to create an executable build package. For example, software build module 112 may utilize testing module 118 to test one or more components of the software. In some embodiments, software build module 112 can secure the executable build package by a digital signature as provenance that the executable build package originated from software build module 112.

License risk module 114 is operable to derive information about risks presented by licenses that govern the use of the software. Software license risk refers to license restrictions for a particular dependency (e.g., software dependency) that affect the ability of the organization to legally use that software in its products. For example, dependencies in the software may be governed by licenses such as Apache, the GNU General Public License (GPL), and MIT, among others. Many of these licenses are incompatible with each other, meaning that certain dependencies cannot be used together since the organization has to comply with all license terms when using the dependencies. In some implementations, license risk module 114 can utilize a software component analysis (SCA) mechanism, such as that provided by BLACK DUCK, TRIVY, or another SCA tool, to scan the software and identify risks presented by licenses that govern the use of software dependencies in the software. For instance, the SCA tool may generate a software bill of materials (SBOM) for the software, which is a complete inventory of the code in the software including the license and version information for the software dependencies. In some embodiments, license risk module 114 can report the dependencies that have license information present and the dependency licenses that are acceptable per policy.

License risk module 114 can provide a report that includes the information about risks presented by licenses that govern the use of the software. In some embodiments, license risk module 114 can secure the report by a digital signature as provenance that the report originated from license risk module 114.

Security risk module 116 is operable to derive information about issues related to known weaknesses in software dependencies that may affect the products that depend on the dependencies. For instance, software, as in the case of large projects, may have a number of software dependencies (e.g., dependencies on third-party code and components) that help with the development of the software. Reliance on software dependencies can lead to software security risks arising from known weaknesses in the use of such dependencies. Non-limiting examples of weaknesses in software dependencies include missing data encryption, operating system command injection, buffer overflow, missing authentication, missing authorization, upload of dangerous file types, and untrusted inputs, among others. For example, security risk module 116 can be configured to scan the software (e.g., source code) for software dependencies and identify any known weaknesses in the software dependencies. In some embodiments, security risk module 116 can report the number of weaknesses that are identified in the software dependencies and, for each identified weakness, the severity of the weakness. In some implementations, security risk module 116 can utilize an SCA mechanism, such as that provided by BLACK DUCK, TRIVY, or another SCA tool, to scan the software and identify weaknesses in the software dependencies in the software.

Security risk module 116 can provide a report that includes the information about issues related to known weaknesses in software dependencies. In some embodiments, security risk module 116 can secure the report by a digital signature as provenance that the report originated from security risk module 116.

Testing module 118 is operable to facilitate automated and manual testing of software. For example, testing module 118 can be configured to test individual units or components of the software to verify its correctness (i.e., verify correct function). Testing may involve debugging and/or analysis. In some embodiments, testing module 118 can report the number of test passed, the number of tests failed, the criticality of the tests passed, the criticality of the tests failed, and code coverage metrics.

Testing module 118 can provide a report that includes the information about the results of the testing of the software. In some embodiments, testing module 118 can secure the report by a digital signature as provenance that the report originated from testing module 118.

Security scan module 120 is operable to derive information about issues related to weaknesses in custom software included in a software build. Custom software may refer to, for example, newly developed or written source code. For example, security scan module 120 can be configured to perform static analysis of the software (e.g., source code) to identify weaknesses in the software and, particularly, weaknesses associated with the custom software. Non-limiting examples of weaknesses in software include programming errors, coding standards violations, undefined values, buffer overflows, improperly handled inputs, and security weaknesses, among others. In more detail, security scan module 120 can perform a static analysis scan of the source code and check the code against predefined coding rules to identify weaknesses in the code (e.g., code that does not comply with the predefined rule or rules). The coding rules may be from coding standards and/or predetermined by the organization. In some embodiments, security scan module 120 can report the number of weaknesses that are identified and, for each identified weakness, the criticality (e.g., high, medium, low) of the weakness and the type/class of the weakness. In some implementations, security scan module 120 can utilize a static code analysis mechanism, such as that provided by Coverity®, Fortify®, or another static code analysis tool, to scan the software and identify weaknesses in the software.

Additionally or alternatively, security scan module 120 can be configured to perform dynamic analysis of the software to identify weaknesses in the software and, particularly, weaknesses in the custom software. For example, security scan module 120 can be configured to perform dynamic analysis of the software (e.g., executing software) to identify weaknesses in the running software and, particularly, weaknesses associated with the running custom software. Weaknesses in the running software may include issues, such as performance issues, that arise during execution. Non-limiting examples of weaknesses in running software (executing software) include potential bugs, performance bottlenecks, memory utilization concerns, runtime crashes, latency, and memory leaks, among others. In more detail, security scan module 120 can analyze and test the software during execution against potential weaknesses. In some embodiments, security scan module 120 can report the number of weaknesses that are identified and, for each identified weakness, the criticality (e.g., high, medium, low) of the weakness and the type/class of the weakness, number of runtime crashes that are identified and the types of runtime crashes, and latency issues (e.g., P90 latency). In some implementations, security scan module 120 can utilize a dynamic code analysis mechanism, such as Peach Fuzzer provided by PEACH FUZZER, LLC, or another dynamic code analysis tool, to analyze the software during execution and identify weaknesses in the running software.

Security scan module 120 can provide a report that includes the information about issues related to weaknesses in custom software included in a software build. In some embodiments, security scan module 120 can secure the report by a digital signature as provenance that the report originated from security scan module 120.

As previously described, build monitoring module 104 can monitor a software build process and generate a provenance bundle (e.g., provenance bundle 110). A provenance bundle generated for a software build contains the artifacts (e.g., reports, executable build package, etc.) from the components of workflow service 106 utilized by build orchestration module 102 to implement a build pipeline associated with the software build. In some embodiments, build monitoring module 104 can include a build provenance in a provenance bundle generated for a software build. Generally, the build provenance describes the actors (e.g., developers, build machines/systems/infrastructure, etc.) and the actions performed by the actors to build the software (e.g., the executable build package). For example, in some embodiments, build monitoring module 104 can include in a build provenance for a software build information such as actions performed by authorized actors, actions performed on authorized infrastructure, actions performed that match planned actions for the software build, and indication as to whether a verifiable chain of artifacts (e.g., source code checkout, build, output) is present, among other information related to the software build. Information for performing the software build such as the authorized actors, authorized infrastructure, and planned actions, may be determined from the software build file that corresponds to the software build.

In the example of FIG. 1, build monitoring module 104 can send or otherwise provide provenance bundle 110 that corresponds to a software build to release decision engine 108 to cause release decision engine 108 to generate a recommendation regarding the releasability of the software build. For example, in an embodiment, build monitoring module 104 can send provide provenance bundle 110 with a request for recommendation for releasability of a software build that corresponds to provenance bundle 110. In response to the request, release decision engine 108 can determine policies 122a, 122b, 122c (122 generally) that are applicable to determining the releasability of the software build and apply the applicable policies 122 to provenance bundle 110 to determine releasability of the software build. Policies 122 may be configured by the organization. The applicable policies 122 specify rules that define one or more conditions that are to be satisfied for the software build to be deemed releasable. For example, the conditions may be evaluated against various information associated with the artifacts in provenance bundle 110, and the releasability of the software build can be determined based on the results of the evaluation. Release decision engine 108 can then provide a release recommendation 124 regarding the releasability of the software build. By way of a simple example, suppose a condition for releasability of a software build is that there is no medium, high, or critical weaknesses in the software. In this example case, if provenance bundle 110 that corresponds to the software build indicates that there is no medium, high, or critical weaknesses in the software, release decision engine 108 can determine the software build to be releasable based on the evaluation of the condition. Conversely, if provenance bundle 110 that corresponds to the software build indicates that there is a medium, high, or critical weaknesses in the software, release decision engine 108 can determine the software build to be not releasable based on the evaluation of the condition.

In some embodiments, release decision engine 108 can secure the recommendation of the releasability of a software build by a digital signature as provenance that the recommendation originated from release decision engine 108. In some embodiments, release decision engine 108 can include a recommendation rational with the recommendation. For example, in cases where the recommendation is to not release the software build, release decision engine 108 can include a recommendation rationale indicating the reason (e.g., indicate the conditions which were not satisfied) for recommending that the software build not be released.

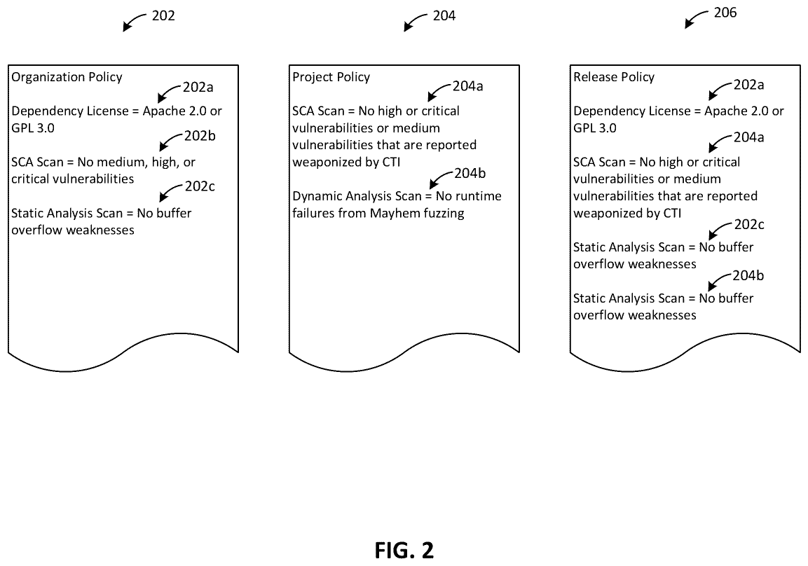

In some embodiments, policies 122 may include different classes of policies. For example, as can be seen in the example of FIG. 1, policy 122a may be an organization policy, policy 122b may be a project policy, and policy 122c may be a customer policy. Organization policy 122a specifies rules that are to be evaluated for all software builds performed by the organization. Project policy 122b specifies rules that are to be evaluated for all software builds associated with a particular project or program (i.e., all software builds provided for a particular project or program). Customer policy 122c specifies rules that are to be evaluated for all software builds performed for a particular customer. The different classes of policies allow policies to be configured for the organization and specific projects and customers. Further description of policies and other processing regarding the policies that can be implemented is provided below at least with respect to FIG. 2.

In some embodiments, release decision engine 108 can incorporate cyber threat intelligence in generating its recommendation regarding the releasability of a software build. Cyber security weaknesses pose significant risks to software security. The cyber threat intelligence may provide good insights as to the releasability of a software build. The cyber threat intelligence may be from sources outside and/or inside the organization. For example, as shown in FIG. 1, a cyber threat intelligence module 126 may be provided as a data source of the cyber threat intelligence to release decision engine 108.

In some embodiments, cyber threat intelligence module 126 can retrieve information about cyber security issues that were encountered by the organization's products (e.g., software products corresponding to the organization's software builds) over their lifespan from the organization's product lifecycle management (PLM) system and other repositories and systems used by the organization to maintain such information. Cyber threat intelligence module 126 can then analyze the retrieved information for intelligence regarding weaknesses (cyber security weaknesses) with respect to the software build and the dependencies included in the software build. Additionally or alternatively, cyber threat intelligence module 126 can utilize a cyber security intelligence mechanism, such as the cyber security and cybercrime intelligence service provided by Intel 471 of Prosper, Texas, or another cyber security intelligence service, for intelligence regarding weaknesses with respect to the software build and the dependencies included in the software build. The intelligence can include reports of any weaponized weaknesses concerning the software build and the dependencies included in the software build. A weaponized weakness refers to a weakness that has been exploited or attacked, for example, by malware.

In some embodiments, cyber threat intelligence module 126 can collect (or “scrape”) and analyze posts and other content from forums and other online platforms known to be frequented and/or used by hackers or other unscrupulous actors for intelligence regarding weaknesses with respect to the software build and the dependencies included in the software build. In one implementation, cyber threat intelligence module 126 can utilize machine learning (ML) models (e.g., neural networks) to process the posts and understand the sentiment, such as boasting, proud, happy, or satisfied, among others, expressed in the text toward or directed toward the software build and/or specific cyber security weaknesses.

Cyber threat intelligence module 126 can send or otherwise provide any identified cyber threat intelligence concerning the software build and the dependencies in the software build to release decision engine 108. For example, cyber threat intelligence module 126 can provide a report that includes the cyber threat intelligence concerning the software build and dependencies included in the software build. In some embodiments, cyber threat intelligence module 126 can secure the report by a digital signature as provenance that the report originated from cyber threat intelligence module 126. Providing cyber threat intelligence in this manner allows release decision engine 108 to incorporate such intelligence in its releasability decision making. For example, if any cyber threat weakness is reported for a software build by cyber threat intelligence module 126, release decision engine 108 can provide a recommendation (e.g., release recommendation 124) to not release the software build. Additionally or alternatively, release decision engine 108 can provide the identified cyber threat weakness as a recommendation rational with the recommendation. In some embodiments, release decision engine 108 can provide information about identified cyber threat weaknesses to a user (e.g., a human user) for further analysis. This allows the user to override the releasability recommendation when necessary. For example, the user may determine the reported cyber threat weakness to be insignificant and not adhere to the non-releasability recommendation made by release decision engine 108.

In some embodiments, build monitoring module 104 may be configured to incorporate a provenance bundle of a software build that has been released into a provenance bundle of a later aggregate software build. An aggregate software build is a software build that incorporates multiple software builds. An aggregate software build can be understood to generate an aggregate product/system. For example, a software build may have been released as a product/system. This product/system may later be incorporated, for example, as a component or dependency, into another software build of an aggregate product/system yet to be released. In this case, the provenance bundle of the software build of the previously released product/system can be incorporated into the provenance bundle of the software build of the aggregate product/system yet to be released. Note that incorporating provenance bundles of released products/systems in this manner effectively reuses the provenance bundles, thereby increasing processing efficiency since the software of the reused provenance bundles need not be processed when processing the build process of the aggregate product/system.

With continued reference to FIG. 1, in an example software development scenario, a developer 128 can create or modify source code and commit the code into a source code repository 130. Developer 128 can provide with the source code a software build file that defines a build pipeline that defines a process for building the software. In response to the commit of the source code or in response to a request for a software build of the source code, build orchestration module 102 can retrieve the source code for the software build from source code repository 130. Build orchestration module 102 can also retrieve the software build file that corresponds to the source code from source code repository 130. Build orchestration module 102 can then utilize the services provided by workflow service 106 to execute a workflow to implement the build pipeline. For example, build orchestration module 102 can make the source code available to the various components of workflow service 106 for implementing the build pipeline of the software build. Build orchestration module 102 can also initiate build monitoring module 104 to monitor the workflow (i.e., software build process). Build monitoring module 104 can start monitoring the workflow that is being performed to build the software and generate a provenance bundle. The provenance bundle contains the artifacts from the software build. Build monitoring module 104 can then provide the provenance bundle to release decision engine 108 to obtain a recommendation (e.g., a decision) regarding the releasability of the software build. For example, build monitoring module 104 can input the provenance bundle to release decision engine 108. In response to the input, release decision engine 108 can determine one or more policies 122 that are applicable to determining the releasability of the software build. Release decision engine 108 can then evaluate the rules specified in the one or more policies 122 against the artifacts in the provenance bundle to determine releasability of the software build. Release decision engine 108 can also evaluate cyber threat intelligence in determining releasability of the software build. Release decision engine 108 can provide release recommendation 124 regarding the releasability of the software build based on the determination. Release decision engine 108 can also store an executable build package that corresponds to the software build and the provenance bundle within a software control data store 132, where they can subsequently be retrieved and used. For example, the executable build package may be retrieved and deployed to a customer. As another example, the provenance bundle may be retrieved and used in an aggregate software build (i.e., a software build of an aggregate product/system).

FIG. 2 is a diagram illustrating a cascading of policies to generate a release policy, in accordance with an embodiment of the present disclosure. As shown, an organization policy 202 and a project policy 204 are cascaded (e.g., aggregated) to generate a release policy 206 to be applied to determine releasability of a software build. Organization policy 202 is to be applied to all software builds performed by the organization and project policy 204 is to be applied to all software builds associated with a particular project or program. The types of policies and the number of policies cascaded in FIG. 2 is merely illustrative and not intended to depict the different types of policies and the number of policies that can be cascaded to generate a release policy.

In the example of FIG. 2, organization policy 202 specifies rules 202a, 202b, 202c. Rule 202a defines a condition for a dependency license (“Dependency License=Apache 2.0 or GPL 3.0”), rule 202b defines a condition for an SCA scan of the software (“SCA Scan=No medium, high, or critical weaknesses”), and rule 202c defines a condition for a static analysis of the software (“Static Analysis Scan=No buffer overflow weaknesses”). Project policy 204 specifies a rule 204a that defines a condition for an SCA scan of the software (“SCA Scan=No high or critical weaknesses or medium weaknesses that are reported weaponized by CTI”) and a rule 204b that defines a condition for a dynamic analysis of the software (“Dynamic Analysis Scan=No runtime failures from Mayhem fuzzing”). The lists of rules shown in organization policy 202 and project policy 204 are merely illustrative and are not intended to depict a complete list of rules which can be specified in organization policy 202 or project policy 204.

In the example of FIG. 2, both rule 202b in organization policy 202 and rule 204a in project policy 204 define a condition for an SCA scan of the software. In this case, the more specific (or “particular”) condition is given priority and included in release policy 206. As a result of the cascading of organization policy 202 and project policy 204, release policy specifies rules 202a, 204a, 202c, 204b.

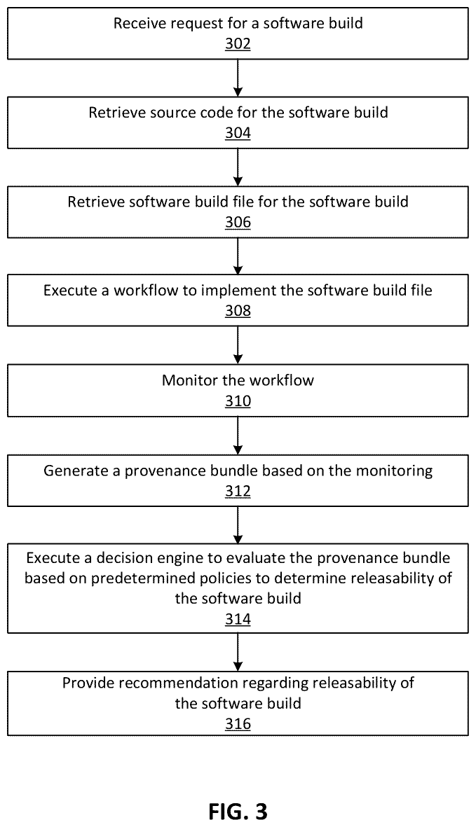

FIG. 3 is a flow diagram of an example process 300 for a software build releasability recommendation, in accordance with an embodiment of the present disclosure. Illustrative process 300 may be implemented, for example, within system 100 of FIG. 1. For purposes of this discussion, it is assumed that a developer (e.g., developer 128 of FIG. 1) within or associated with an organization commits source code and a software build file to a source code repository (e.g., source code repository 130 of FIG. 1). It is also assumed that the developer sends a request for a software build of the source code.

With reference to process 300 of FIG. 3, at 302, the request for the software build may be received. For example, build orchestration module 102 can receive and process the request for the software build of the source code.

At 304, the source code for the software build may be retrieved. For example, build orchestration module 102 can retrieve the source code for the software build from source code repository 130. The retrieved source code is the source code committed by the developer.

At 306, the software build file for the software build may be retrieved. For example, build orchestration module 102 can retrieve the software build file from source code repository 130. The retrieved software build file defines a build pipeline of the software build (e.g., defines a build pipeline for building the software).

At 308, a workflow to implement the software build file may be executed. For example, build orchestration module 102 can execute the workflow to implement the build pipeline defined by the retrieved software build file. The workflow can be implemented utilizing various components of workflow service 106.

At 310, the workflow may be monitored. For example, build monitoring module 104 can monitor the workflow executed at 308. Build monitoring module 104 can be initiated to perform the monitoring by build orchestration module 102.

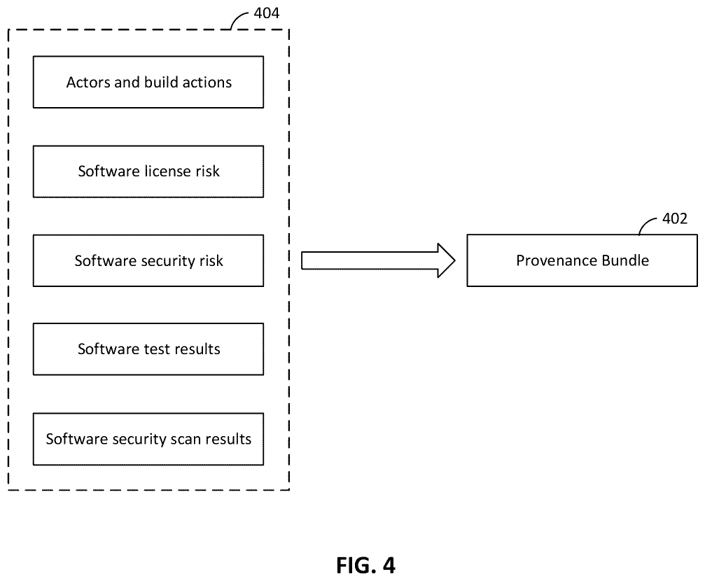

At 312, a provenance bundle may be generated based on the monitoring of the workflow. For example, build monitoring module 104 can generate the provenance bundle based on the monitoring of the workflow. The generated provenance bundle can contain the artifacts from the software build. The artifacts describe the performance of the various build events and the results of the build events during the build of the software. For example, as shown in FIG. 4, a provenance bundle 402 may include one or more artifacts 404 from a software build. Provenance bundle 402 may correspond to the provenance bundle generated by build monitoring module 104 at 312. As illustrated in FIG. 4, artifacts 404 can describe the actors and the actions taken by the actors to build the software release, software license risk, software security risk, software test results, and software security scan results, as previously described herein.

Referring again to process 300 of FIG. 3, at 314, a decision engine may be executed to evaluate the provenance bundle based on predetermined policies to determine releasability of the software build. For example, upon generating the provenance bundle, build monitoring module 104 can initiate execution of release decision engine 108 to determine releasability of the software build. In response, release decision engine 108 can determine policies 122 that are applicable to determining the releasability of the software build and evaluate the rules specified in policies against the artifacts in the provenance bundle to determine releasability of the software build.

At 316, a recommendation may be provided regarding releasability of the software build. For example, release decision engine 108 can provide a recommendation regarding releasability of the software release based on the determination made at 314. Release decision engine 108 can also provide a recommendation rationale indicating the reason for its recommendation. The recommendation may then be reviewed by the organization and a final decision can be made regarding the releasability of the software. In some embodiments, release decision engine 108 can store an executable build package from the software build and the provenance bundle within software control data store 132.

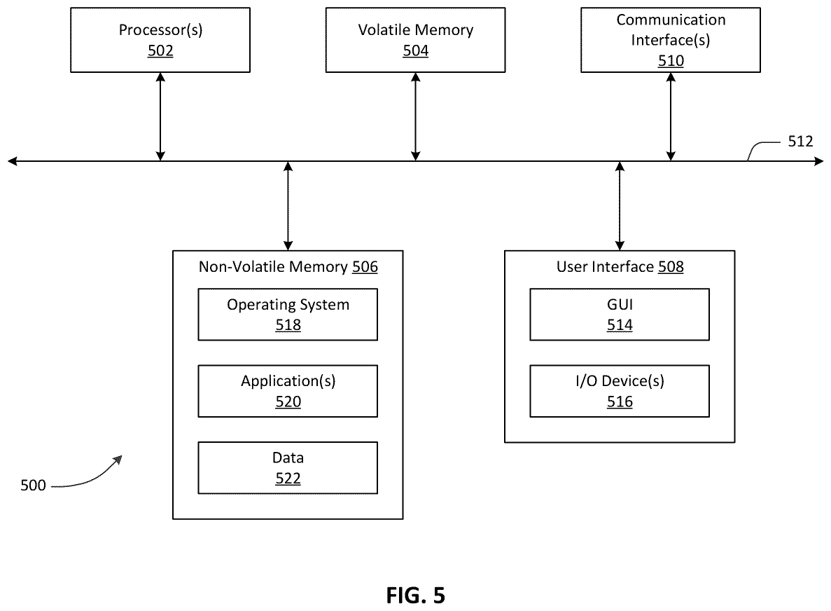

FIG. 5 is a block diagram illustrating selective components of an example computing device 500 in which various aspects of the disclosure may be implemented, in accordance with an embodiment of the present disclosure. For example, illustrative computing device 500 can perform all or part of the processes described herein. As shown, computing device 500 includes one or more processors 502, a volatile memory 504 (e.g., random access memory (RAM)), a non-volatile memory 506, a user interface (UI) 508, one or more communications interfaces 510, and a communications bus 512.

Non-volatile memory 506 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 508 may include a graphical user interface (GUI) 514 (e.g., a touchscreen, a display, etc.) and one or more input/output (I/O) devices 516 (e.g., a mouse, a keyboard, a microphone, one or more speakers, one or more cameras, one or more biometric scanners, one or more environmental sensors, and one or more accelerometers, etc.).

Non-volatile memory 506 stores an operating system 518, one or more applications 520, and data 522 such that, for example, computer instructions of operating system 518 and/or applications 520 are executed by processor(s) 502 out of volatile memory 504. In one example, computer instructions of operating system 518 and/or applications 520 are executed by processor(s) 502 out of volatile memory 504 to perform all or part of the processes described herein (e.g., processes illustrated and described with reference to FIGS. 1 through 4). In some embodiments, volatile memory 504 may include one or more types of RAM and/or a cache memory that may offer a faster response time than a main memory. Data may be entered using an input device of GUI 514 or received from I/O device(s) 516. Various elements of computing device 500 may communicate via communications bus 512.

The illustrated computing device 500 is shown merely as an illustrative client device or server and may be implemented by any computing or processing environment with any type of machine or set of machines that may have suitable hardware and/or software capable of operating as described herein.

Processor(s) 502 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 502 may be analog, digital, or mixed signal. In some embodiments, processor 502 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 510 may include one or more interfaces to enable computing device 500 to access a computer network such as a Local Area Network (LAN), a Wide Area Network (WAN), a Personal Area Network (PAN), or the Internet through a variety of wired and/or wireless connections, including cellular connections.

In described embodiments, computing device 500 may execute an application on behalf of a user of a client device. For example, computing device 500 may execute one or more virtual machines managed by a hypervisor. Each virtual machine may provide an execution session within which applications execute on behalf of a user or a client device, such as a hosted desktop session. Computing device 500 may also execute a terminal services session to provide a hosted desktop environment. Computing device 500 may provide access to a remote computing environment including one or more applications, one or more desktop applications, and one or more desktop sessions in which one or more applications may execute.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
receiving, by a computing device, a request for a software build; and
responsive to receipt of the request for the software build, by the computing device:
retrieving source code for the software build;
retrieving a software build file for the software build, the software build file defining a build pipeline;
executing a workflow to implement the software build file;
generating a provenance bundle based on a monitoring of the workflow;
executing a decision engine to evaluate the provenance bundle based on one or more predetermined policies to thereby generate a recommendation regarding releasability of the software build; and
providing the recommendation regarding releasability of the software build to another computing device.

2. The method of claim 1, wherein the executing the decision engine includes evaluating cyber threat intelligence.

3. The method of claim 2, wherein the cyber threat intelligence is determined using a machine learning (ML) model.

4. The method of claim 1, wherein the recommendation includes a recommendation rationale.

5. The method of claim 1, wherein the provenance bundle includes one or more artifacts about the software build, one of the one or more artifacts regarding actors and the actions taken by the actors.

6. The method of claim 1, wherein the provenance bundle includes one or more artifacts about the software build, one of the one or more artifacts regarding software license risk.

7. The method of claim 1, wherein the provenance bundle includes one or more artifacts about the software build, one of the one or more artifacts regarding known weaknesses in software dependencies.

8. The method of claim 1, wherein the provenance bundle includes one or more artifacts about the software build, one of the one or more artifacts regarding software test results.

9. The method of claim 1, wherein the provenance bundle includes one or more artifacts about the software build, one of the one or more artifacts regarding weaknesses in custom software included in the software build.

10. A computing device comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
receiving a request for a software build; and
responsive to receipt of the request for the software build:
retrieving source code for the software build;
retrieving a software build file for the software build, the software build file defining a build pipeline;
executing a workflow to implement the software build file;
generating a provenance bundle based on a monitoring of the workflow;
executing a decision engine to evaluate the provenance bundle based on one or more predetermined policies to thereby generate a recommendation regarding releasability of the software build; and
providing the recommendation regarding releasability of the software build to another computing device.

11. The computing device of claim 10, wherein the executing the decision engine includes evaluating cyber threat intelligence.

12. The computing device of claim 11, wherein the cyber threat intelligence is determined using a machine learning (ML) model.

13. The computing device of claim 10, wherein the recommendation includes a recommendation rationale.

14. The computing device of claim 10, wherein the provenance bundle includes one or more artifacts about the software build, one of the one or more artifacts regarding actors and the actions taken by the actors.

15. The computing device of claim 10, wherein the provenance bundle includes one or more artifacts about the software build, one of the one or more artifacts regarding software license risk.

16. The computing device of claim 10, wherein the provenance bundle includes one or more artifacts about the software build, one of the one or more artifacts regarding known weaknesses in software dependencies.

17. The computing device of claim 10, wherein the provenance bundle includes one or more artifacts about the software build, one of the one or more artifacts regarding software test results.

18. The computing device of claim 10, wherein the provenance bundle includes one or more artifacts about the software build, one of the one or more artifacts regarding weaknesses in custom software included in the software build.

19. A non-transitory machine-readable medium encoding instructions that when executed by one or more processors cause a process to be carried out, the process including:
receiving a request for a software build; and
responsive to receipt of the request for the software build:
retrieving source code for the software build;
retrieving a software build file for the software build, the software build file defining a build pipeline;
executing a workflow to implement the software build file;
generating a provenance bundle based on a monitoring of the workflow;
executing a decision engine to evaluate the provenance bundle based on one or more predetermined policies to thereby generate a recommendation regarding releasability of the software build; and
providing the recommendation regarding releasability of the software build to another computing device.

20. The non-transitory machine-readable medium of claim 19, wherein the executing the decision engine includes evaluating cyber threat intelligence.
